(19) United States
(12) Patent Application Publication
(10) Pub. No.: US 2006/0037820 A1
(43) Pub. Date: Feb. 23, 2006

(54) Drum furnished with ventilation means, and brake furnished with such a drum

(75) Inventors: Franck Cazenave, Senlis (FR); Olivier Bugada, Moussy Le Neuf (FR); Gerard Luu, Noisy Le Grand (FR)

Correspondence Address: LEO H MCCORMICK, 2112 MISHAWAKA AVE, P O BOX 4721, SOUTH BEND, IN, 46634, US

(73) Assignee: Robert Bosch GmbH

(21) Appl. No.: 11/196,859

(22) Filed: Aug. 4, 2005

(30) Foreign Application Priority Data
Aug. 20, 2004 (FR) 04/09018

(51) Int. Cl. F16D 55/02

(52) U.S. Cl. 188/71.6

(57) ABSTRACT

A drum (2) for a brake having a series of fins (12) that are secured via a first end (16) to an external wall (11) of the drum. The fins alternate on the external wall of the drum. It is possible to provide an outer annulus (10) surrounding the drum, a second end (17) of the fins being secured to said outer annulus. Another subject of the invention is a drum brake (1) comprising such a drum.

The subject of the invention is a drum for a drum brake for a motor vehicle. More specifically, the subject of the invention is a drum equipped with ventilation means. Such ventilation means may prove necessary to quickly dissipate the heat created at the site of the drum during braking. Another subject of the invention is a brake equipped with such a drum.

One object of the invention is to provide a drum equipped with ventilation means that is simple to produce. Another object of the invention is to provide a drum brake equipped with effective ventilation means, but with a low total weight. An additional object of the invention is to reduce the cost of manufacture of a drum equipped with ventilation means.

### BACKGROUND OF THE INVENTION

A drum brake is generally equipped with an endplate or plate, fixed to the hub of a wheel, with a drum located within the wheel and with a brake cylinder fixed to the endplate. The drum is circular and moves with the wheel. Two shoes are mounted between the endplate and the drum. The two shoes follow the contour of the drum. The shoes are in the shape of an arc of a circle and are arranged inside the wheel drum. One end of the first shoe rests against a first piston of a brake cylinder, while one end of the second shoe rests against a second piston opposite the first piston of said brake cylinder. Each shoe is equipped, on an external face, with a lining. The external face of a shoe is intended to mean the face facing towards the internal wall of the drum.

Under braking, a brake control, for example a brake pedal, actuates the brake cylinder. The pistons of the brake cylinder push the shoes back against the internal wall of the drum. The lining therefore come into contact with the internal wall of the drum. Friction of the linings against the drum opposes the rotation of the drum. The vehicle is therefore braked. At the end of braking, the return of the shoes to the rest position is performed, for example, by a return spring. The rest position is to be understood as meaning the position in which the shoes are not expanded. The shoes are away from the internal wall of the drum. The linings no longer rub against the drum. Braking is over.

During braking, the rubbing of the linings against the internal wall of the drum creates heat. It is necessary for it to be possible for this heat to be removed from the inside of the drum to the outside.

This is because if the heat is unable to be dissipated, or is dissipated poorly, the drum tends to expand under the effect of the increase in temperature inside said drum. The radius of curvature of the linings then no longer corresponds to the radius of curvature of the internal wall of the drum. During -subsequent braking operations, contact between the linings and the internal wall of the drum is no longer uniform, certain regions of the linings being in closer contact than others with the internal wall of the drum. Braking cannot be fully satisfactory, and lining wear is uneven.

Furthermore, the overheating and the actual wear of the linings are exasperated by this phenomenon. This is because the regions of the linings in closest contact with the internal wall are subjected most to overheating. This overheating leads to even greater local expansion, and the wear of these regions of the linings therefore tends to increase.

Aside from the fact that it is then necessary to change the linings of such a drum brake frequently, this overheating phenomenon may also cause poor braking because contact between the linings and the internal wall of the drum is uneven.

In order to remedy this disadvantage of overheating in the drum brake, document FR 2 836 531 discloses producing a drum brake equipped with ventilation means. The ventilation means comprise a series of curved fins arranged over an entire height of an external wall of the drum. The height of the external wall of the drum is understood to mean the dimension of said wall running parallel to an axis of rotation of the wheel bearing the drum. A curved fin is understood to mean a fin having a radius of curvature at the location of a region of contact between the fin and the external wall of the drum. The heat loss area in the drum brake is thus increased. Such a solution makes it possible to create a ventilation effect. Furthermore, depending on the orientation of the fins, and more specifically on their radii of curvature, it is possible to guide the air from the inside of the drum outward.

These fins, generally termed turbine blade fins, make it possible to optimize the dissipation of the heat energy present in the drum brake during braking.

Generally, the drum, an outer annulus surrounding the drum, and the fins secured to the drum and to the outer annulus are produced in a single piece. This is because it is known that heat dissipates more quickly through a one-piece part than through a component made of several parts joined together.

Producing a brake comprising turbine blade fins is a complicated matter. Because of the radii of curvature of the fins, it is necessary, during release from the mold, to rotate the two parts of the mold simultaneously and in opposite directions in order to release each fin. The longer the fins, the more difficult it is to release them from the mold. Furthermore, the mold itself is complicated because it has to be equipped with a core and with special core tooling to allow mold release.

Furthermore, with turbine blade fins, it is necessary to produce two different variants of brakes equipped with ventilation means, so that the ventilation of the drums under braking is as effective on the right-hand wheels as it is on the left-hand wheels of the vehicle. This is because the air is ventilated toward the outboard side or the inboard side of the vehicle according to the orientation of the radius of curvature of the turbine blade fins on the external wall of the drum. Obviously, the dissipation of heat is optimal when the air is directed toward the outboard side of the vehicle. Producing two different variants increases the cost of manufacture of a vehicle equipped with such drum brakes.

### SUMMARY OF THE INVENTION

The invention seeks to solve the above problems by providing a drum brake able to dissipate effectively the heat that builds up in the drum brake during braking, whether it be mounted on the right-hand wheel or the left-hand wheel, which is of a simple design and of low cost of manufacture. The invention also seeks to produce such a drum brake with a rather low total weight.

In order to arrive at this result, a drum brake that can be equipped with an outer annulus surrounding the drum and that comprises a plurality of fins arranged on an external wall of the drum, the fins being arranged in a staggered configuration, is produced. What this means to say is that the fins are arranged in an alternating or zig-zag manner on the external wall of the drum. One fin in two is secured to the external wall of the drum at the site of a first half-height of said wall, while the other fins are themselves secured to the external wall of the drum at the site of the second half-height of the external wall of the drum. Thus, the air circulates from the inside of the drum toward the outside at an angle. Such an arrangement of the fins makes it possible in all cases to discharge the air from the inside of the drum to the outside of the vehicle. Just one variant is therefore used for the wheels on both sides of the vehicle.

In one particular embodiment of the invention, rounded edges are produced at the site of a connection between the fins and the outer wall of the drum. What this means to say is that a quantity of material at the site of the connection between the edges and the drum is greater than a quantity of material at the site of the connection between the edges and the outer annulus. This additional amount of material results in a local increase in thickness on the outer wall of the drum. Thus, the rigidity of the drum is improved. It is therefore possible to reduce the thickness of the drum. The thickness of the drum is to be understood as meaning the dimension perpendicular to the axis of rotation of the wheel equipped with said drum brake. The total weight of the drum can thus be reduced.

The subject of the invention is therefore a drum comprising a series of fins secured to an external wall of the drum, a height of this wall running parallel to an axis of rotation of the drum, characterized in that an installation of the fins is alternated on the external wall of the drum, from opposite ends of the height of said wall.

The drum of the invention may also comprise all or some of the following features:

a width of the fins runs parallel to the axis of rotation of the drum and is strictly shorter than the height of the external wall of the drum;

the width of the fins is more or less equal to half the height of the external wall of the drum;

the drum is equipped with an outer annulus surrounding said drum, a first end of the fins being secured to the external wall of the drum and a second end of the fins being secured to the outer annulus;

the fins are straight;

a connection between a first end of the fins and the drum is flared;

a thickness of the drum extends in a direction perpendicular to the axis of rotation of the drum and is shorter than a thickness of the outer annulus, the thickness of the outer annulus running in a direction perpendicular to the axis of rotation of the drum.

Another subject of the invention is a drum brake equipped with such a drum. In one particular embodiment of the drum brake, said brake is equipped with a one-piece assembly comprising the drum, an outer annulus and the series of fins.

The invention will be better understood from reading the description which follows and from examining the accompanying figures. These are given by way of entirely nonlimiting indication of the invention.

### BRIEF DESCRIPTION OF THE DRAWINGS

FIG. 1: a schematic depiction of a drum brake according to one embodiment of the invention;

FIG. 2: a schematic depiction of a one-piece assembly comprising a drum, fins and an outer annulus according to one embodiment of the invention;

FIG. 3: a partial depiction of a one-piece assembly according to another embodiment;

FIG. 4: a schematic depiction in section on a plane parallel to the axis of rotation of the wheel, of an outer wall of a drum of the invention;and

FIG. 5: a partial depiction in section on a plane parallel to the axis of rotation of the wheel, of a mold capable of producing a brake of the invention.

### DETAILED DESCRIPTION OF THE INVENTION

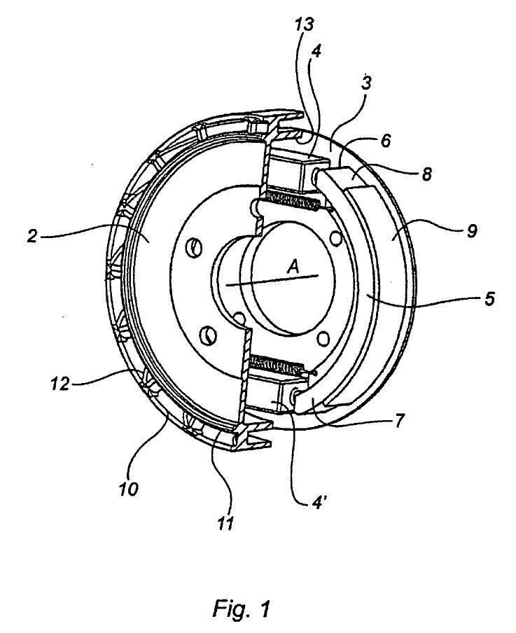

FIG. 1 depicts a drum brake 1 equipped with a drum 2. An end plate 3 bears two brake cylinders 4 and 4′ arranged one on each side of a diameter of said end plate 3. Two shoes 5 (just one is visible in FIG. 1) rest via a first end 6 against a housing of the first brake cylinder 4 and via a second end 7 against a housing of the second brake cylinder 4′. Each shoe 5 is equipped on an outer face 8 with a lining 9. The shoes 5 are in the shape of an arc of a circle, so as to follow the internal circular contour of the drum 2. The shoes 5 are arranged between the end plate 3 and the drum 2. Of course, it is possible for the shoes 5 to be articulated via a single brake cylinder 4 or 4′. The second brake cylinder 4 or 4′ can therefore be replaced by an articulation.

FIG. 1 shows that the drum brake 1 is also equipped with an outer annulus 10. The outer annulus 10 has a radius of curvature that follows a radius of curvature of the drum 2. Between the outer annulus 10 and an external wall 11 of the drum 2 is arranged a series of fins 12. The external wall 11 of the drum 2 is to be understood as meaning a wall facing toward the vehicle wheel in which it is mounted, as opposed to an internal wall 13 of the said drum 2, facing toward the shoes 5 and the linings 9.

In a different embodiment of the invention, it may be anticipated for the outer annulus 10 to be omitted.

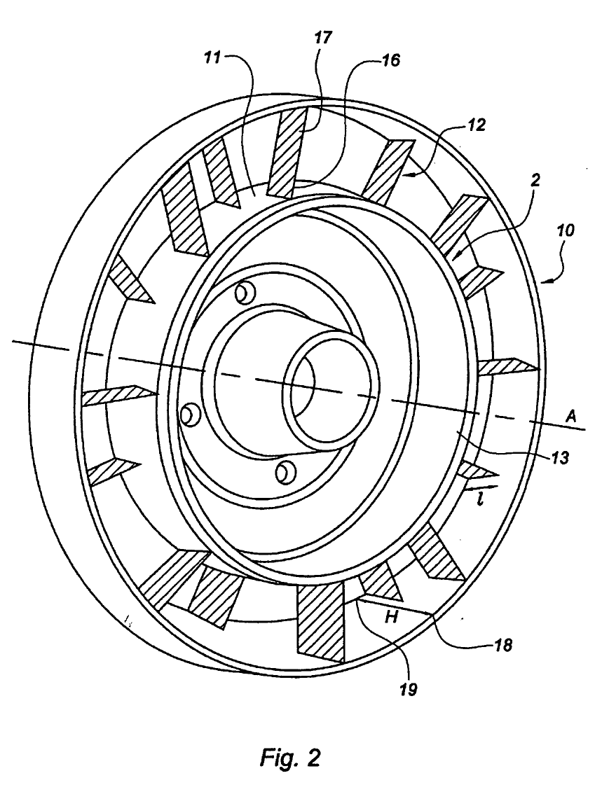

FIG. 2 depicts in greater detail the drum 2 of the invention, the outer annulus 10 and the series of fins 12. As can be seen, according to the invention, the series of fins 12 comprises fins fitted alternately on the external wall 11 of the drum 2. A height H of the external wall 11 of the drum 2 comprises an internal end 18, intended to face toward the inside of the vehicle, and an external end 19. One fin 12 in two has an installation beginning at the site of the internal end 18 of the height H of the external wall 11 of the drum 2, while one fin 12 in two itself has an installation beginning at the site of the external end 19 of the height H of the external wall 11 of the drum 2. A width 1 of the fins 12 is strictly shorter than the height H of the external wall 11 of the drum 2, and so the zig-zag installation forces the air to separate when it encounters the fins on entering the drum 2, creating ventilation. The width 1 of a fin 12 is to be understood as meaning the dimension of the fin 12 that runs parallel to the axis of rotation A of the drum 2.

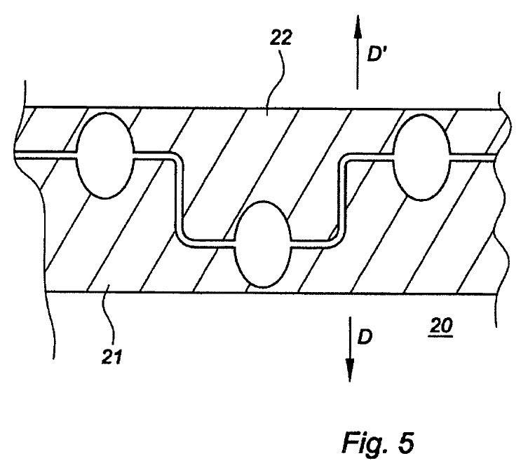

FIG. 4 shows more schematically the alternating arrangement of the fins 12. Specifically, the fins 12 have, for example, a width 1 corresponding to half the height H of the external disk 10 or of the drum 2.

In the embodiment depicted in FIGS. 2 and 4, the fins 12 are straight fins, that is to say fins with no radius of curvature. The fins are, for example, formed of flat sheet, that is to say sheet of which a cross section on a plane perpendicular to the axis A of rotation has a rectangular profile. Such a shape of the fins 12, because of their alternating arrangement on the drum 2, yields good results in terms of ventilating the drum brake 1.

The drum brake 1 equipped with a one-piece assembly comprising at least the drum 2, the outer annulus 10 and the series of straight fins 12 is easy to produce. FIG. 5 shows a schematic partial cross section of a mold 20 allowing the production of a one-piece assembly 2, 10, 12 of the invention. The mold 2 is in two parts 21 and 22, the edges of cut-outs of which are such that once molding has been performed, the parts 21 and 22 are separated by parting them from one another in opposite and mutually parallel directions D and D′. It is possible to release the parts of the one-piece assembly 2, 10, 12 molded in the parts 21 and 22 of the mold 20 simultaneously or in two operations.

Furthermore, such a one-piece assembly 2, 10, 12 in which the fins 12 are straight fins allows a single variant of drum brake 1 to be produced that can be mounted with equal ease on the right-hand wheels and the left-hand wheels of a motor vehicle, and provides the same effectiveness of ventilation.

In another embodiment of the invention, provision may be made for the use of fins 12 with a radius of curvature. That means to say that the fins 12 are, for example, formed of a sheet of which a cross section in a plane perpendicular to the axis A has a profile in the shape of an arc of a circle.

It is also possible to produce a drum brake 1 equipped with straight fins and curved fins, arranged, for example, in alternation on the external wall 11 of the drum 2.

However, these solutions may prove more complicated to produce, particularly if there is a desire to produce a one-piece assembly comprising the drum 2, the outer annulus 10 and the fins 12. Furthermore, in both these two instances, it is necessary each time to produce two different variants, one to be mounted on the wheels situated on the right-hand side of the vehicle and the other to be mounted on the wheels situated on the left-hand side of said vehicle.

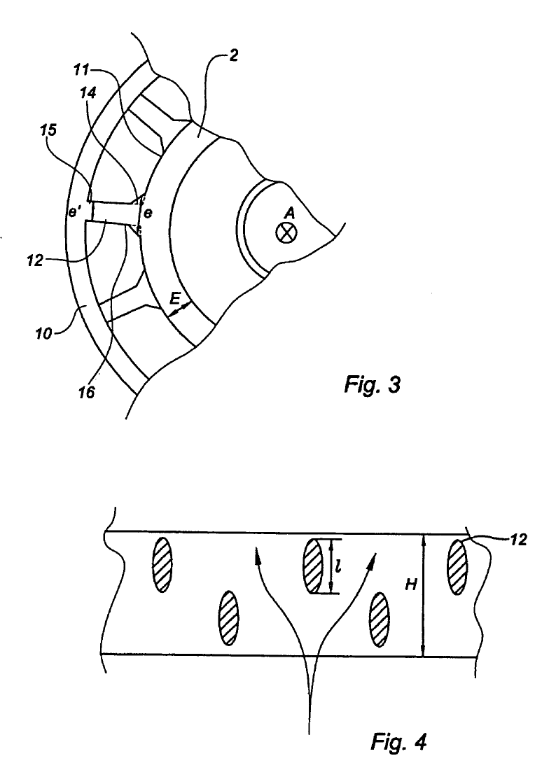

In one particular embodiment of the invention and as depicted in FIG. 3, a connection 14 between a fin 12 and the outer wall 11 of the drum 2 is formed of an additional thickness 14. What this means to say is that a thickness e of the fin 12 at the site of the connection 14 between the fin 12 and the drum 2 is greater than a thickness e′ of said fin 12 at the site of the connection 15 between said fin 12 and the outer annulus 10. The thickness e or e′ of the fin 12 is to be understood as meaning the dimension of the fin that runs in a plane parallel to a mean plane of the external wall 11 of the drum 2 at the site of the connection 14. Such a connection 14 equipped with a rounded edge allows the rigidity of the drum 2 to be increased.

In addition, because of this additional quantity of material at the site of the connection 14, it is possible to reduce a thickness E of the drum 2 while at the same time maintaining sufficient drum stiffness. The thickness E is to be understood as meaning the dimension of the drum 2 perpendicular to the axis of rotation A. Thus, the total weight of the drum brake 1 equipped with such ventilation means is not penalized by its weight, because the addition of material due to the presence of the fins, and possibly of the outer annulus 10, is partially compensated for by the reduction in the amount of material at the site of the drum 2.

1. A drum (2) for a brake (1) comprising a series of fins (12) secured to an external wall (11) of the drum, a height (h) of this wall running parallel to an axis (a) of rotation of the drum,characterized in that an installation of the fins is alternated on the external wall of the drum, from opposite ends (18, 19) of the height of said wall:

2. The drum according to claim 1, characterized in that a width (1) of the fins runs parallel to the axis of rotation of the drum and is strictly shorter than the height of the external wall of the drum.

3. The drum according to claim 2, characterized in that the width of the fins is more or less equal to half the height of the external wall of the drum.

4. The drum according to claim 3, characterized by with an outer annulus (10), said outer annulus surrounding the drum, a first end (16) of the fins being secured to the external wall of the drum and a second end (17) of the fins being secured to the outer annulus.

5. The drum according to claim 4, characterized in that a thickness (E) of the drum extends in a direction perpendicular to the axis of rotation of the drum and is shorter than a thickness of the outer annulus, the thickness of the outer annulus running in a direction perpendicular to the axis of rotation of the drum.

6. The drum according to claim 5, characterized in that the fins are straight.

7. The drum according to claim 6, characterized in that a connection (14) between a first end (16) of the fins and the drum is flared.

8. (canceled)

9. The drum brake according to claim 7, characterized by a one-piece assembly (2, 10, 12) comprising the drum, an outer annulus (10) and the series of fins.
